(19) United States
(12) Patent Application Publication
(10) Pub. No.: US 2008/0000434 A1
(43) Pub. Date: Jan. 3, 2008

(54) HARNESS

(75) Inventor: Ian Hulbert, Aberfeldy (GB)

Correspondence Address: LUNDEEN & DICKINSON, LLP, PO BOX 131144, HOUSTON, TX, 77219-1144, US

(73) Assignee: BLUESKY TELEMETRY LIMITED, Aberfeldy (GB)

(21) Appl. No.: 11/427,992

(22) Filed: Jun. 30, 2006

(51) Int. Cl. A01K 27/00

(52) U.S. Cl. 119/859

(57) ABSTRACT

The invention relates to a harness for attaching electronic apparatus to a beast. The harness is configured to be attached to a beast. The harness comprises a strap 12 formed at least in part of two strap members 30, 32, the two strap members being joined to each other at spaced apart locations 34, 36. The two strap members define a space 38 between the joins such that the space is capable of receiving electronic apparatus 40, 42.

### FIELD OF THE INVENTION

The present invention relates to a harness for attaching electronic apparatus to a beast and a method of attaching electronic apparatus to a beast.

### BACKGROUND OF THE INVENTION

It is known to attach telemetry apparatus to wild beasts. Such telemetry apparatus may be used to track the location of a wild beast, e.g. by means of a Global Positioning System (GPS) receiver or an Inertial Navigation System (INS). Typically, the telemetry or INS apparatus is attached to the beast by means of a harness. More specifically, the telemetry apparatus is secured to the harness and the harness is then secured to the beast.

The harness may take one of a number of different forms depending on the breed and size of the beast and the nature of the telemetry apparatus. In its simplest form the harness consists of a pliable collar that is secured around the neck of the beast by means of a buckle.

### SUMMARY OF THE INVENTION

The present inventor has appreciated certain shortcomings of such known harnesses for attaching telemetry apparatus to beasts. Thus it is an object of the present invention to provide a harness for attaching electronic apparatus, such as telemetry apparatus, to a beast.

According to a first aspect of the present invention, there is provided a harness for attaching electronic apparatus to a beast, the harness being configured to be attached to a beast, the harness comprising a strap formed at least in part of two strap members, the two strap members being joined to each other at spaced apart locations, the two strap members defining a space between the joins such that the space is capable of receiving electronic apparatus.

In use, electronic apparatus, such as telemetry apparatus, is located in the space defined by the two strap members. Thus, the two strap members can provide protection for the electronic apparatus, e.g. against blows inflicted on the harness by the beast to which the harness is attached or against the elements. In known harnesses, electronic apparatus is normally suspended from or attached to the harness thus making the electronic apparatus susceptible to damage.

More specifically, the harness may be configured such that, in use, the two strap members may be adjacent the skin of the beast to which the harness is attached. Thus, electronic apparatus contained within the space defined by the two strap members may be adjacent the skin of the animal. This may be advantageous where the electronic apparatus is operable to measure movement of the beast, e.g. by means of an accelerometer. More specifically, having the electronic apparatus adjacent the skin of the beast may provide for proper measurement of movement by having the strap and hence the electronic apparatus mirror the movement of the beast. In known harnesses in which the electronic apparatus is not adjacent the skin of the beast, e.g. where it is suspended from the harness, the electronic apparatus may move independently of the beast and thus not provide a proper measurement of the beast's movement.

Alternatively or in addition, one of the two strap members may comprise further electronic apparatus.

More specifically, the further electronic apparatus may be embedded in the one of the two strap members. Thus, where the harness is configured such that, in use, the two strap members are adjacent the skin of the beast to which the harness is attached, the further electronic apparatus may be adjacent the skin of the beast. The further electronic apparatus may comprise sensor apparatus operative to sense a vital sign, such as the heart beat, of the beast.

Alternatively or in addition, the two strap members may be joined to each other towards their respective opposing edges.

Alternatively or in addition, the two strap members may be joined to each other by at least one join such that the two strap members are integrally formed with each other. In use, such a join can provide for better protection against ingress of water compared, for example, with forming the join by sewing the two strap members together.

More specifically, the two strap members may be joined at respective opposing edges such that the joins are formed integrally with both of the strap members.

Alternatively or in addition, profiles of the two strap members may overlap.

More specifically, the two strap members may have substantially coextensive profiles.

Alternatively or in addition, at least one edge of one strap member may be substantially coterminous with a respective edge of the other strap member.

More specifically, a join may extend generally along the coterminous edges of the two strap members.

Alternatively or in addition, the two strap members may be elongate.

More specifically, the joins between the two strap members may extend generally along the two strap members.

Alternatively or in addition, the two strap members may be pliable.

More specifically, the two strap members may be moveable from a first disposition, in which opposing surfaces of the two strap members are adjacent, to a second disposition, in which the opposing surfaces of the two strap members are spaced apart from each other. Thus, when the two strap members are spaced apart from each other the two strap members define the space for receiving the electronic apparatus.

More specifically, the two strap members may be configured such that they can be moved from the first disposition to the second disposition in response to a manual operation of a user.

More specifically, the two strap members may be configured such that as the user compresses opposing edges of the two strap members the two strap members move from the first disposition to the second disposition.

Alternatively or in addition, an exterior surface of at least one of the two strap members may be comprised of a waterproof material. More specifically, the waterproof material may comprise a plastics material. Thus the plastics material may provide a barrier to the ingress of moisture and water and thereby prevent water damage to electronic apparatus contained in the harness.

More specifically, the plastics material may be Poly Vinyl Chloride (PVC).

Alternatively or in addition, at least one of the two strap members may comprise a fabric layer, the fabric layer facing a surface of the other strap member.

The fabric layer may give the strap strength. Also, the fabric layer may provide for repeated bending of the strap members whilst reducing the likelihood that such bending will damage the strap members.

More specifically, the fabric layer may comprise a synthetic polymer, such as polyester.

Use of a synthetic polymer, such as polyester, imparts high tensile characteristics to the fabric layer thereby improving upon the capability to bend the strap member without damage.

Where a strap member comprises a fabric layer and where an exterior surface of the strap member comprises a plastics material, the fabric layer and the plastics material may be attached to each other.

More specifically, the fabric layer and the plastics material may be attached by means of the plastics material itself. For example, during manufacture the plastics material may have been softened, e.g. by heating, such that it bonds to the fabric layer.

Alternatively or in addition, the strap may be formed substantially entirely of the two strap members.

Alternatively or in addition, the harness may be comprised solely of the strap.

More specifically, the strap may be configured to fit around a neck of the beast. Thus the strap may form a collar.

More specifically, the strap may be configured to describe a circumference of between about 0.35 m and about 3 m when attached to a beast.

Alternatively or in addition, the strap may be configured for adjustment of its length when attached to a beast.

More specifically, a length of the strap may be adjustable by between about 5% and about 15% of its length.

Alternatively or in addition, the harness may further comprise fastening apparatus for securing the harness to a beast.

More specifically, the fastening apparatus may be configured for releasably securing the harness to the beast.

Alternatively or in addition, the fastening apparatus may be configured to mechanically couple an end of a strap of the harness to an opposing end of the strap.

More specifically, the fastening apparatus may comprise at least one pair of nuts and bolts, the at least one pair of nuts and bolts being operable to fasten the end of the strap of the harness to the opposing end of the strap. More specifically, at least one aperture is provided towards each of the opposing ends of the strap. In use, the opposing ends of the strap are brought together such that their apertures are brought into registration with each other. The bolt may then be inserted through the apertures and the nut threaded onto the bolt and tightened whereby the ends of the strap may be securely attached to each other.

Alternatively or in addition, the at least one pair of nuts and bolts may be formed of a synthetic polymer, such as nylon.

Alternatively or in addition, the fastening apparatus may comprise a buckle attached at or towards an end of the strap, the buckle being configured to mechanically couple to the opposing end of the strap. A buckle can provide for quick release of the harness from a beast.

According to a second aspect of the invention there is provided a method of attaching electronic apparatus to a beast, the method comprising: locating electronic apparatus in a space defined by joining two strap members to each other at spaced apart locations; and attaching a harness comprising a strap formed at least in part of the two strap members to a beast.

Embodiments of the second aspect of the present invention may comprise one or more features of the first aspect of the invention.

According to a third aspect of the present invention, there is provided telemetry apparatus comprising a harness according to the first aspect of the invention and electronic apparatus.

More specifically, the electronic apparatus may comprise at least one of a GPS receiver, Global System for Mobile (GSM) communications apparatus, an Inertial Navigation System (INS), a UHF transmitter and a VHF transmitter.

Alternatively or in addition, the electronic apparatus may comprise an antenna (e.g. for a GPS receiver or for a VHF transmitter). The antenna may be disposed in the space defined by the two strap members.

Alternatively or in addition, the electronic apparatus may comprise a battery. The battery may be operable to provide electrical power for the electronic apparatus. The battery may be disposed in the space defined by the two strap members.

Further embodiments of the third aspect of the present invention may comprise one or more features of the first aspect of the invention.

### BRIEF DESCRIPTION OF THE DRAWINGS

Further features and advantages of the present invention will become apparent from the following specific description, which is given by way of example only and with reference to the accompanying drawings, in which:

FIG. 1 shows a harness embodying the present invention;

FIG. 2a is a perspective view showing part of the harness of FIG. 1 in detail;

FIG. 2b is an end view showing part of the harness of FIG. 1; and

FIG. 3 is a view of part of a harness having an alternative form of fastening apparatus to that of the harness shown in FIG. 1.

### DETAILED DESCRIPTION

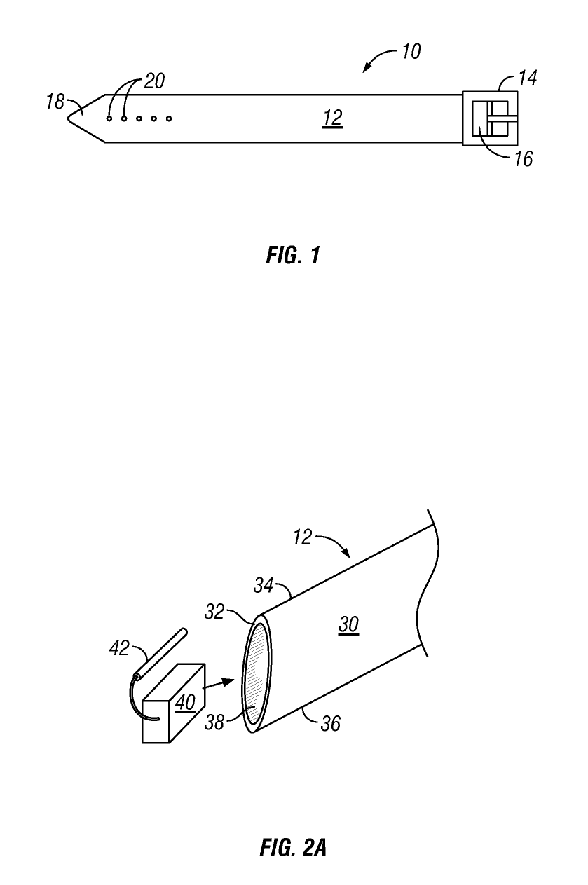

FIG. 1 shows a harness 10 configured to be fitted around the neck of a beast and thereby secured to the beast. The harness comprises a pliable strap 12 and a buckle 14 (which constitutes fastening apparatus) attached to one end 16 of the strap 12. The second, opposing end 18 of the strap is tapered and has a number of spaced apart apertures 20.

In use, the strap 12 is wrapped around the neck of the beast, and the strap securely attached to the beast by bringing the tapered end 18 of the strap into engagement with the buckle 14. The series of apertures 20 allow the circumference of the strap to be altered when the strap is attached to the beast. The length of the strap when attached can be changed by this means by between about 5% and 15% of given length. The buckle 14 provides for quick release of the harness 10 from the beast. The strap 12 is between about 0.35 m and about 3 m in length. A particular length of strap 12 is chosen depending on the size of the beast to which the harness is to be attached.

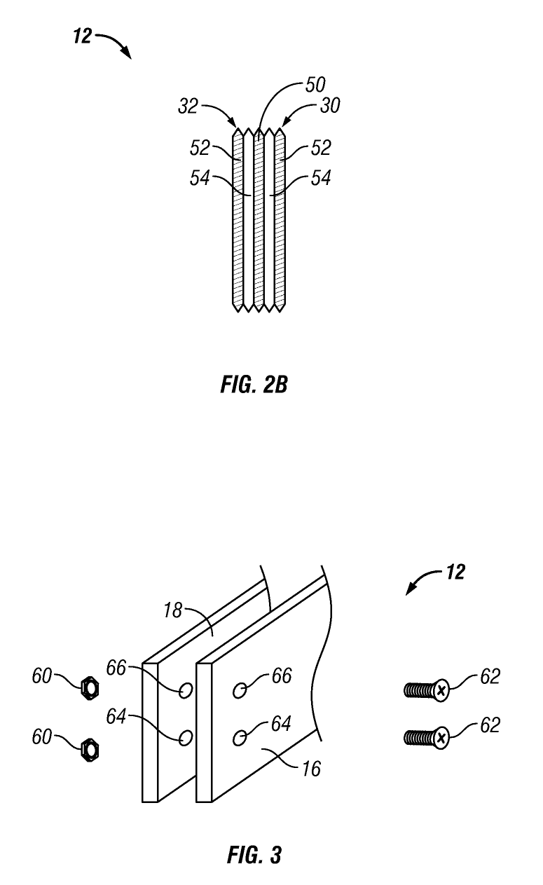

FIG. 2a provides a perspective view of part of the length of the strap 12 shown in FIG. 1. The strap comprises two strap members 30, 32 that are joined to each other at opposing edges 34, 36 of the strap, the opposing edges 34, 36 extending along the length of the strap. Each edge 34, 36 is joined such that the two strap members 30, 32 are integrally formed with each other. The two strap members 30, 32 are pliable. Thus upon application of pressure to the opposing edges 34, 36, e.g. by a user pressing the opposing edges 34, 36 between his fingers and thumb, opposing faces of the two strap members move apart such that the two strap members define a space 38. The space 38 thus defined is of sufficient volume to receive electronic apparatus comprising a GPS receiver and a VHF transmitter 40 and an antenna 42 for transmitting signals from the VHF transmitter to a remote location. Such transmitted signals provide information on the location of the beast to which the harness 10 is attached. The electronic apparatus also comprises a battery to provide electrical power for operation of the GPS receiver and the VHF transmitter 40. With reference to FIG. 1, two strap members are not joined together across the width of the tapered end 18 of the strap, thereby providing an opening for insertion of the electronic apparatus into the space defined by the two strap members. One of the two strap members has a heart beat sensor embedded within the strap. In use, the strap member having the heart beat sensor is located against the skin of the beast and the sensor provides a measure of heart beat. The electronic apparatus 40 provides a heart rate measurement in dependence on the measured heart beat.

As can be seen from FIG. 2a, each opposing edge 34, 36 of the strap 12 has a rounded profile. Thus, the strap is less likely than straps having sharp edges, for example as formed of leather, to bite into the skin of the beast to which the harness is attached.

FIG. 2b shows a detailed end view of the strap 12 of FIGS. 1 and 2a. The strap 12 is shown where no pressure has been applied to the opposing edges shown in FIG. 2a and as described above. Thus, the opposing faces of the two strap members 30, 32 are adjacent such that the two strap members define no space or very little space 50 between them depending on the resilience of the material of the two strap members. Each of two strap members has a first outer layer 52 formed of PVC and a second inner layer 54 formed of a polyester woven fabric. The first PVC layer 52 of each strap member forms an outer surface to the strap 12 and by virtue of its material properties provides a barrier to water and moisture. Thus the PVC layer 52 makes the strap 12 water and weather proof. The second woven fabric layer 54 forms an inner surface to the strap 12 and by virtue of its high tensile characteristics provides for repeated bending of the strap 12 whilst reducing the likelihood that the strap 12 will be damaged by bending.

During manufacture the PVC layer 52 is softened, e.g. by heating, and the second woven fabric layer 54 pressed into the softened PVC such that the PVC layer 52 and the second woven fabric layer 54 bond to each other. When the electronic apparatus is inserted into the space 38 defined by the two strap members the open end of the strap 12 through which the electronics is inserted is sealed to prevent the electronics apparatus falling out of the space and to prevent water ingress. The open end may be sealed by heating the ends 18 of the two strap members so that the PVC in each strap member softens. The ends of the two strap members are then pressed together such that the softened PVC bonds them together.

As shown in FIG. 3, the buckle is replaced in another form of the harness with two pairs of nuts 60 and bolts 62 formed of nylon. Two spaced apart apertures 64, 66 are provided in each of the opposing ends 16, 18 of the strap 12. In use, the strap 12 is wrapped around the neck of a beast and the opposing ends brought together such that a first 64 of the two apertures in the first end 16 is in registration with a first 64 of the two apertures in the second end 18 and a second 66 of the two apertures in the first end 16 is in registration with a second 66 of the two apertures in the second end 18. A bolt 62 is inserted through the first apertures 64 in the first and second ends and a bolt 62 is inserted through the second apertures 66 in the first and second ends. A nut 60 is threaded onto each bolt 62 and tightened to securely attach the first 16 and second 18 ends to each other.

In use, locating the electronic apparatus in the space 38 defined by the two strap members 30, 32 provides protection for the electronic apparatus 40, 42. For example, the electronic apparatus is provided with protection against blows received by the harness 10 when attached to a beast or against the ingress of moisture or water.

1. A harness for attaching electronic apparatus to a beast, the harness being configured to be attached to a beast, the harness comprising a strap formed at least in part of two strap members, the two strap members being joined to each other at spaced apart locations, the two strap members defining a space between the joins such that the space is capable of receiving electronic apparatus.

2. A harness according to claim 1, in which the harness is configured such that, in use, the two strap members are adjacent the skin of the beast to which the harness is attached.

3. A harness according to claim 1, in which one of the two strap members comprises further electronic apparatus.

4. A harness according to claim 3, in which the further electronic apparatus is embedded in the one of the two strap members.

5. A harness according to claim 4, in which the further electronic apparatus comprises sensor apparatus operative to sense a vital sign of the beast.

6. A harness according to claim 1, in which the two strap members are joined to each other towards their respective opposing edges.

7. A harness according to claim 1, in which the two strap members are joined to each other by at least one join such that the two strap members are integrally formed with each other.

8. A harness according to claim 7, in which the two strap members are joined at respective opposing edges such that the joins are formed integrally with both of the strap members.

9. A harness according to claim 1, in which profiles of the two strap members overlap.

10. A harness according to claim 9, in which the two strap members have substantially coextensive profiles.

11. A harness according to claim 1, in which at least one edge of one strap member is substantially coterminous with a respective edge of the other strap member.

12. A harness according to claim 11, in which a join may extend generally along the coterminous edges of the two strap members.

13. A harness according to claim 1, in which the two strap members are elongate.

14. A harness according to claim 13, in which the joins between the two strap members extend generally along the two strap members.

15. A harness according to claim 1, in which the two strap members are pliable.

16. A harness according to claim 15, in which the two strap members are moveable from a first disposition, in which opposing surfaces of the two strap members are adjacent, to a second disposition, in which the opposing surfaces of the two strap members are spaced apart from each other.

17. A harness according to claim 16, in which the two strap members are configured such that they can be moved from the first disposition to the second disposition in response to a manual operation of a user.

18. A harness according to claim 17, in which the two strap members are configured such that as the user compresses opposing edges of the two strap members the two strap members move from the first disposition to the second disposition.

19. A harness according to claim 1, in which an exterior surface of at least one of the two strap members is comprised of a waterproof material.

20. A harness according to claim 19, in which the waterproof material comprises a plastics material.

21. A harness according to claim 20, in which the plastics material is Poly Vinyl Chloride (PVC).

22. A harness according to claim 1, in which at least one of the two strap members comprises a fabric layer, the fabric layer facing a surface of the other strap member.

23. A harness according to claim 22, in which the fabric layer comprises a synthetic polymer.

24. A harness according to claim 22, in which an exterior surface of the strap member comprises a plastics material, the fabric layer and the plastics material are attached to each other.

25. A harness according to claim 24, in which the fabric layer and the plastics material are attached by means of the plastics material itself.

26. A harness according to claim 1, in which the strap is formed substantially entirely of the two strap members.

27. A harness according to claim 26, in which the strap is configured to fit around a neck of the beast.

28. A harness according to claim 27, in which the strap is configured to describe a circumference of between about 0.35 m and about 3 m when attached to a beast.

29. A harness according to claim 1, in which the strap is configured for adjustment of its length when attached to a beast.

30. A harness according to claim 29, in which a length of the strap is adjustable by between about 5% and about 15% of its length.

31. A harness according to claim 1, in which the harness further comprises fastening apparatus for securing the harness to a beast.

32. A harness according to claim 31, in which the fastening apparatus is configured for releasably securing the harness to the beast.

33. A harness according to claim 1, in which the fastening apparatus is configured to mechanically couple an end of a strap of the harness to an opposing end of the strap.

34. A harness according to claim 33, in which the fastening apparatus comprises at least one pair of nuts and bolts, the at least one pair of nuts and bolts being operable to fasten the end of the strap of the harness to the opposing end of the strap.

35. A harness according to claim 34, in which at least one aperture is provided towards each of the opposing ends of the strap and, in use, the opposing ends of the strap are brought together such that their apertures are brought into registration with each other, the at least one bolt being inserted through the at least one aperture and the nut threaded onto the bolt whereby the ends of the strap are securely attached to each other.

36. A harness according to claim 34, in which the at least one pair of nuts and bolts are formed of a synthetic polymer.

37. A harness according to claim 1, in which the fastening apparatus comprises a buckle attached at or towards an end of the strap, the buckle being configured to mechanically couple to the opposing end of the strap.

38. A method of attaching electronic apparatus to a beast, the method comprising: locating electronic apparatus in a space defined by joining two strap members to each other at spaced apart locations; and attaching a harness comprising a strap formed at least in part of the two strap members to a beast.

39. Telemetry apparatus comprising a harness according to claim 1 and further comprising electronic apparatus.

40. Telemetry apparatus according to claim 39, in which the electronic apparatus comprises at least one of a GPS receiver, Global System for Mobile (GSM) communications apparatus, an Inertial Navigation System (INS), a UHF transmitter and a VHF transmitter.

41. Telemetry apparatus according to claim 39, in which the electronic apparatus comprises an antenna.
